(19) United States
(12) Patent Application Publication
(10) Pub. No.: US 2013/0095704 A1
(43) Pub. Date: Apr. 18, 2013

(54) CABLE CONNECTING STRUCTURE

(71) Applicants: Yoshikazu Awakura, Hamamatsu-Shi (JP); Hidetoshi Kato, Hamamatsu-Shi (JP); Masayuki Ikeno, Hamamatsu-Shi (JP); Yuji Kitamura, Hamamatsu-Shi (JP)

(72) Inventors: Yoshikazu Awakura, Hamamatsu-Shi (JP); Hidetoshi Kato, Hamamatsu-Shi (JP); Masayuki Ikeno, Hamamatsu-Shi (JP); Yuji Kitamura, Hamamatsu-Shi (JP)

(73) Assignee: SUZUKI MOTOR CORPORATION, Shizuoka-Ken (JP)

(21) Appl. No.: 13/695,134

(22) PCT Filed: Apr. 25, 2011
(86) PCT No.: PCT/JP2011/060054

§ 371 Date: Dec. 20, 2012

(30) Foreign Application Priority Data
Apr. 30, 2010 (JP) 2010-105258

(51) Int. Cl. H01R 4/24

(52) U.S. Cl. CPC H01R 4/24
USPC 439/709

(57) ABSTRACT

A connecting structure of a cable having circular terminals for electrically connecting to connecting sections of a unit that requires electric power, and flange sections that are conjoined to a terminal block to be fixed to the unit. The terminal block is provided with connection-direction conversion members to which the connecting sections and the circular terminals are to be fixed, and the terminal block is fixed to the unit after the circular terminals are fixed to the connection direction conversion members, and the flange sections are fixed to the terminal block.

### PRIORITY CLAIM

This patent application is a U.S. National Phase of International Patent Application No. PCT/JP2011/060054, filed 25 Apr. 2011, which claims priority to Japanese Patent Application No. 2010-105258, filed 30 Apr. 2010, the disclosures of which are incorporated herein by reference in their entirety.

### TECHNICAL FIELD

The present invention relates to a cable connecting structure, and more particularly, to a cable connecting structure for connecting a cable to a unit which requires electric power.

### BACKGROUND ART

With reference to FIG. 5, a vehicle such as an electric automobile is mounted with a unit 101 requiring an electric power including, for example, a high voltage unit or invertor.

Such unit 101 is connected with a cable 108, for example, a high-voltage cable or the like. As illustrated in FIG. 6, the cable 108 includes a round terminal 112 which is electrically connected to a connection portion 105 of the unit 101, and a flange portion 113 which is coupled with a terminal block 107 to be fixed to the unit 101. The flange portion 113 functions as a connector portion for the purposes of waterproof and shield earth.

### PRIOR ART DOCUMENT

### Patent Document

Patent Document 1: Japanese Patent Laid-Open Publication No. 2004-153904

A cable terminal structure with a shield layer is disclosed as a conventional art in the Patent Document 1 mentioned above. In this terminal structure, one end of a cylindrical fitting is interposed between an exposed insulator and the shield layer, and a flange portion is incorporated into the cylindrical fitting. The other end of the cylindrical fitting is inserted into a through hole of a panel, and the flange portion is fixed to the panel by means of screw.

### DISCLOSURE OF THE INVENTION

### Problems to be Solved by The Invention

Conventionally, in the cable connecting structure illustrated in FIG. 5, it is required to connect of the cable 108 by clamping the cable 108 at two sections, with a connection bolt 121 from a lateral direction X on the side of the round terminal 112 and with a coupling bolt 122 from a downward direction Y on the side of the flange portion 113.

However, a clamping direction (lateral direction X) of the connection bolt 121 and a clamping direction (downward direction Y) of the coupling bolt 122 require the clamping from two directions perpendicular to each other. Therefore, in the layout of the unit 101, if there exists an obstacle D in at least one of the two clamping directions as shown in FIGS. 5 and 6, it is difficult to perform a clamping operation, which will interfere with the layout and make it difficult to secure a space for performing the clamping operation from the two directions.

As also illustrated in FIG. 7, in a case where a connecting section is shifted to a position at which an operation is enabled, that is, i.e., when the terminal block 107 is arranged laterally in order to secure the space for performing the clamping operation, the length of the cable 108 is obliged to be partially longer as indicated by an L portion, thus causing a disadvantage of an increase in cost and weight.

In view of the circumstances mentioned above, it is an object of the present invention to provide a cable connecting structure that facilitates layout of components and minimizes the length of a connection cable.

### Means for Solving The Problem

In order to achieve the above object, a cable connection structure according to the present invention includes:
a round terminal electrically connected to a connection portion of a unit requiring electric power; and
a flange portion coupled to a terminal block fixed to the unit,
wherein the terminal block includes a connecting direction conversion member to which the connection portion of the unit and the round terminal are fixed, the terminal block is fixed to the unit after the round terminal is fixed to the connecting direction conversion member, and the flange portion is fixed to the terminal block.

It may be further preferred that a fixing direction for the round terminal and the connecting direction conversion member is arranged so as to constitute a perpendicular relationship with a fixing direction for the flange portion and the terminal block.

### Effects of The Invention

According to the cable connecting structure of the present embodiment mentioned above, the cable is connected to the unit by assembling working from one direction to thereby facilitate the layout of components and minimize the length of the cable.

### BRIEF DESCRIPTION OF THE DRAWINGS

FIG. 1 is a perspective view of a terminal block which is mounted with cables according to an embodiment of the present invention.

FIG. 2 is a perspective view showing a part of a unit connected with the terminal block illustrated in FIG. 1.

FIG. 3 is a perspective view of the cable illustrated in FIG. 1.

FIG. 4 is a perspective view of the unit connected with the terminal block of a cable connecting structure according to an embodiment of the present invention.

FIG. 5 is a perspective view of a unit connected with a terminal block in a cable connecting structure of a conventional technology.

FIG. 6 is a perspective view of the cable of the conventional structure illustrated in FIG. 5.

FIG. 7 is a view illustrating a state where the length of the cable cannot be minimized by changing a connecting section of a conventional round terminal.

### EMBODIMENT FOR CARRYING OUT THE INVENTION

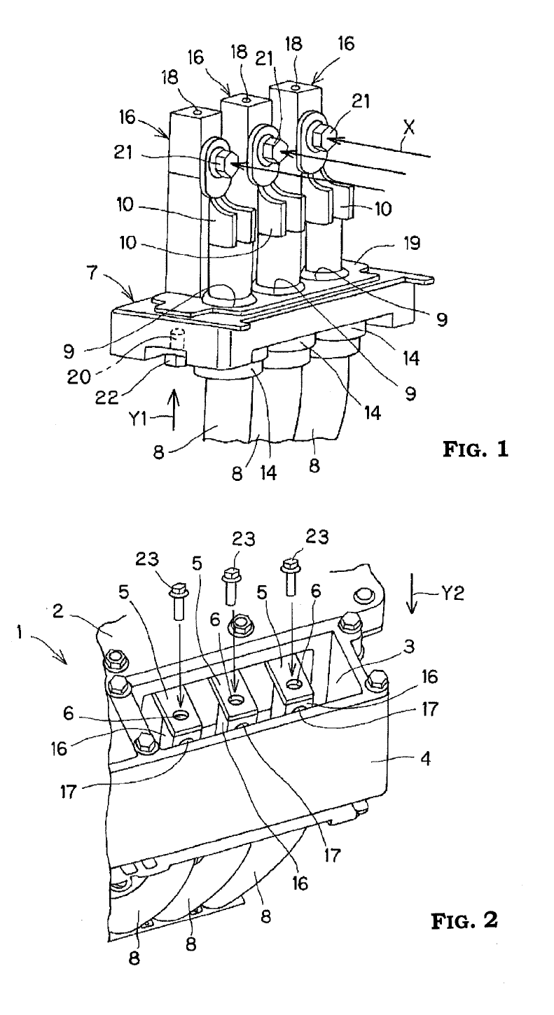

An embodiment of the present invention will be described hereunder with reference to the accompanying drawings (FIGS. 1 to 4). It is further to be noted that terms indicating “direction” (right, left, front, back and the like) are used herein with reference to the illustration of the drawings or in a usual mounted state of components of a cable connecting structure.

FIGS. 1 to 4 illustrate an embodiment of the present invention, in which the layout of components is facilitated and an object of minimizing the length of a cable is achieved by providing a cable connecting structure for connecting the cable to a unit by being assembled from one direction.

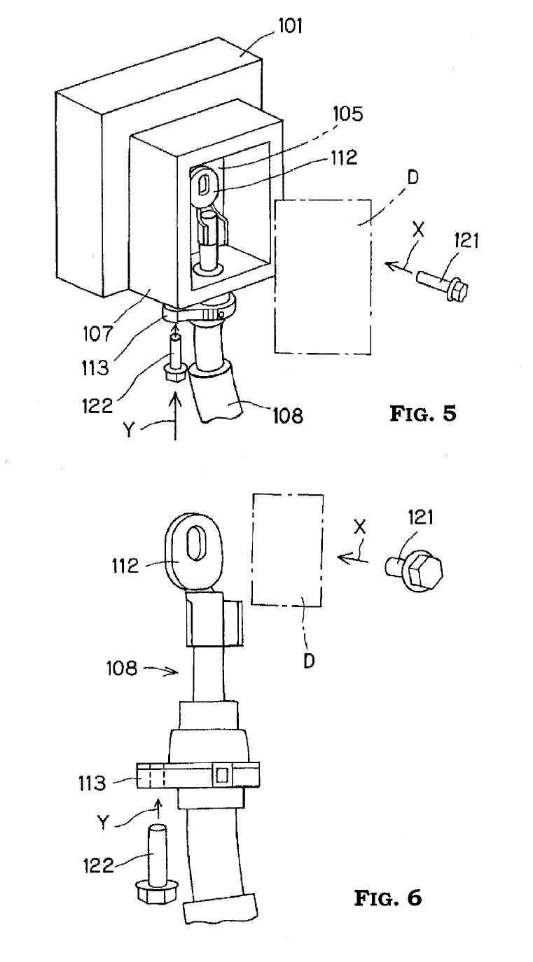

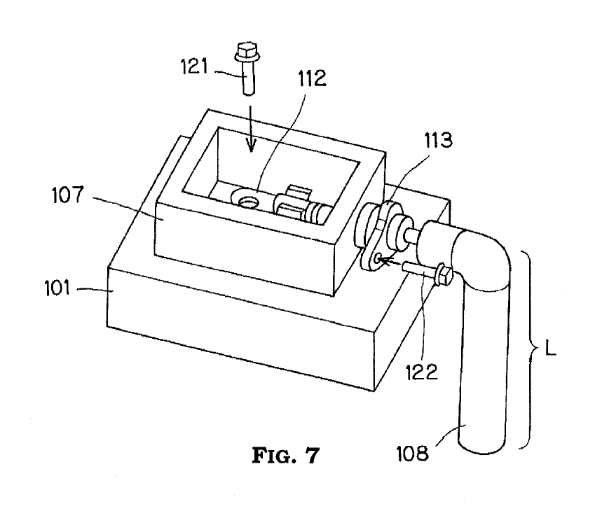

In FIG. 4, reference numeral 1 denotes a unit composed of a high-voltage unit, or a unit including such as inverter, which is mounted on a vehicle such as an electric automobile and requires electric power.

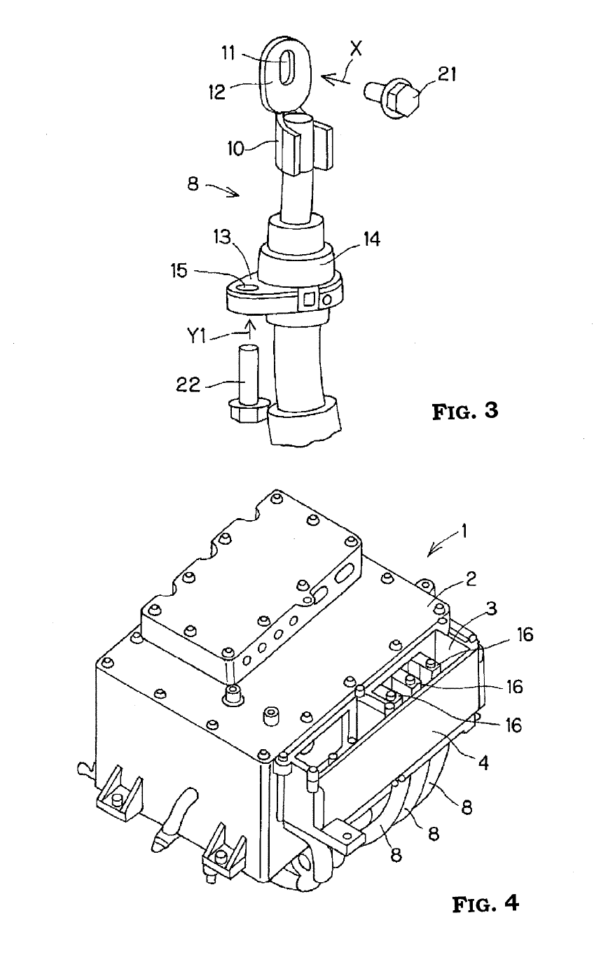

The unit 1 includes a unit body 2 as well as a cover member 4 having a U-shape in a plan view. The cover member 4 is mounted on one side portion of the unit body 2 so as to form a cable connecting space 3 that penetrates in the vertical direction of the cover member 4. As illustrated in FIG. 2, for example, three plate-shaped connection portions 5, 5, 5 are provided side by side at a predetermined interval from each other on the one side portion of the unit body 2. These connection plates 5 are formed each as connection portion (bus bar) extending in the horizontal direction inside the cable connecting space 3. The connection portions 5, 5, 5 are respectively formed with fixing bolt holes 6, 6, 6.

In the cable connecting space 3, the terminal block 7, which is fixed to the unit 1, is arranged and three cables 8, 8, 8 are arranged so as to respectively correspond to the three connection portions 5, 5, 5. Accordingly, as illustrated in FIG. 1, cable holes 9, 9, 9 through which the cables 8, 8, 8 are respectively inserted are formed in the terminal block 7.

A single cable 8 will be described hereunder with reference to FIG. 3. The cable 8 includes a round terminal 12, which is held by a holding member 10 at a front (tip) end portion thereof so as to be electrically connected to the corresponding connection portion 5 of the unit 1, and the round terminal 12 is formed with a connection bolt hole 11 penetrating therethrough in a lateral direction X.

The cable 8 also includes a flange portions 13 which is coupled with the terminal block 7. The flange portion 13 is fixed to the cable 8 through an interposing member 14, and formed with a coupling bolt hole 15 which penetrates in the perpendicular direction at one end side thereof.

As illustrated in FIG. 1, the terminal block 7 is provided with connecting direction conversion members 16 to which the connection portions 5 of the unit 1 and the round terminals 12 of the cables 8 are fixed, respectively. The connecting direction conversion members 16 are provided upright on an upper surface of the terminal block 7 so as to extend upward at positions corresponding respectively to the connection portions 5.

As illustrated in FIG. 2, each of the connecting direction conversion members 16 is formed with a connecting screw hole 17 in one side surface in the lateral direction X and also has a fixing screw hole 18 in the upper surface as illustrated in FIG. 1.

A water-proof sheet 19 is laid on the upper surface of the terminal block 7, and coupling screw holes 20 are formed in the terminal block 7 at positions corresponding respectively to the coupling bolt holes 15 of the flange portions 13.

At a time when the terminal block 7 is fixed to the unit 1, connection bolts 21 are first inserted into the respective connection bolt holes 11 of the round terminals 12 from the lateral direction X and then clamped into the respective connecting screw holes 17 of the connecting direction conversion members 16 to fix the round terminals 12 respectively to the connecting direction conversion members 16. Then, coupling bolts 22 are inserted into the respective coupling bolt holes 15 of the flange portions 13 from the lower side, i.e., a fixing direction Y1, and then clamped into the respective coupling screw holes 20 of the terminal block 7 to fix the flange portions 13 to the terminal block 7, thereby setting the terminal block 7 to the cable 8 in advance.

Thereafter, fixing bolts 23 are inserted into the respective fixing bolt holes 6 of the connection portions 5 from the upper direction, i.e., a fixing direction Y2, and then clamped into the respective fixing screw holes 18 of the connecting direction conversion members 16, thereby fixing the terminal block 7 to the unit 1.

As a result, it is only necessary to clamp the fixing bolts 23 from one upward direction, i.e., the fixing direction Y2, so as to connect the cable 8 to the unit 1. This facilitates the layout of components and eliminates the need to secure a space for a special clamping operation. Further, the degree of freedom of clamping is increased and the length of the cable 8 can be minimized.

The fixing direction X for fixing the round terminals 12 to the connecting direction conversion members 16 and the fixing direction Y1 for fixing the flange portions 13 to the terminal block 7 are arranged perpendicularly to each other as illustrated in FIG. 1. On the other hand, the fixing direction Y2 for fixing the connection portions 5 to the connecting direction conversion members 16 is set in only one upward direction. Therefore, the fixation in the two perpendicular directions is finished first, so that the unit body 2 can be fixed only in one upward direction.

This is especially effective when the fixing direction X for fixing the round terminals 12 to the connecting direction conversion members 16 and the fixing direction Y1 for fixing the flange portions 13 to the terminal block 7 are arranged perpendicularly to each other.

### INDUSTRIAL APPLICABILITY

A cable connecting structure according to this invention is applicable not only to a high-voltage cable and a high-voltage unit, but also to various vehicles.

### Reference Numeral

1 - - - unit
2 - - - unit body
5 - - - connection portion (bus-bar)
7 - - - terminal block
8 - - - cable
12 - - - round terminal
13 - - - flange portion
16 - - - connecting direction conversion member
21 - - - connection bolt
22 - - - coupling bolt
23 - - - fixing bolt

1. A cable connecting structure comprising:
a round terminal electrically connected to a connection portion of a unit requiring electric power; and
a flange portion coupled to a terminal block fixed to the unit,
the terminal block including a connecting direction conversion member to which the connection portion of the unit and the round terminal are fixed, the terminal block being fixed to the unit after the round terminal is fixed to the connecting direction conversion member and the flange portion is fixed to the terminal block.

2. The cable connecting structure according to claim 1, wherein a fixing direction for the round terminal and the connecting direction conversion member is arranged so as to constitute a perpendicular relationship with a fixing direction for the flange portion and the terminal block.
